(19) United States
(12) Patent Application Publication
(10) Pub. No.: US 2024/0427025 A1
(43) Pub. Date: Dec. 26, 2024

(54) POSITION PERFORMANCE IMPROVEMENT AT TUNNEL EXIT

(71) Applicant: QUALCOMM Incorporated, San Diego, CA (US)

(72) Inventors: Qutubuddin MOHAMMED, Santa Clara, CA (US); Lohitha RATNARAJ, Pleasanton, CA (US); Yuxiang PENG, Sunnyvale, CA (US)

(21) Appl. No.: 18/340,719

(22) Filed: Jun. 23, 2023

(51) Int. Cl. G01S 19/22

(52) U.S. Cl. CPC G01S 19/22

(57) ABSTRACT

A method for determining a tunnel exit of a user equipment, includes: determining a tunnel entry of the user equipment; determining that the user equipment is receiving signals from one or more satellite vehicles; determining whether one or more parameters based on the signals received by the user equipment indicate a line of sight between the user equipment and the one or more satellite vehicles; and determining no tunnel exit of the user equipment in response to determining that the one or more parameters indicate no line of sight between the user equipment and at least one of the one or more satellite vehicles.

### BACKGROUND

Global navigation satellite systems (GNSS) are used to determine a global position and/or location of any number of mobile stations. A GNSS may include a constellation of orbiting satellites that each transmit a time-synchronized signal. A mobile station may receive the time-synchronized signal from a number of GNSS satellites. By determining a time of transmission associated with each received time-synchronized signal and having knowledge of the location of each of the satellites that transmitted each received time-synchronized signal, the mobile station may determine its global location. The typical resolution of GNSS systems is typically in the range of two to three meters, however, this resolution may be reduced when the time-synchronized signals are obstructed by natural and man-made barriers, such as mountains, canyons, urban canyons, and tunnels.

### SUMMARY

An example method for determining a tunnel exit of a user equipment according to the disclosure, includes: determining a tunnel entry of the user equipment; determining that the user equipment is receiving signals from one or more satellite vehicles; determining whether one or more parameters based on the signals received by the user equipment indicate a line of sight between the user equipment and the one or more satellite vehicles; and determining no tunnel exit of the user equipment in response to determining that the one or more parameters indicate no line of sight between the user equipment and at least one of the one or more satellite vehicles.

An example computing device, includes: means for determining a tunnel entry of a user equipment; means for determining that the user equipment is receiving signals from one or more satellite vehicles; means for determining whether one or more parameters based on the signals received by the user equipment indicate a line of sight between the user equipment and the one or more satellite vehicles; and means for determining no tunnel exit of the user equipment in response to determining that the one or more parameters indicate no line of sight between the user equipment and at least one of the one or more satellite vehicles.

An example non-transitory, processor-readable storage medium includes processor-readable instructions to cause one or more processors to: determine a tunnel entry of a user equipment; determine that the user equipment is receiving signals from one or more satellite vehicles; determine whether one or more parameters based on the signals received by the user equipment indicate a line of sight between the user equipment and the one or more satellite vehicles; and determine no tunnel exit of the user equipment in response to determining that the one or more parameters indicate no line of sight between the user equipment and at least one of the one or more satellite vehicles.

An example user equipment, includes: one or more memories; and one or more processors communicatively coupled to the one or more memories, the one or more processors being configured to: determine a tunnel entry of the user equipment; determine that the user equipment is receiving signals from one or more satellite vehicles; determine whether one or more parameters based on the signals received by the user equipment indicate a line of sight between the user equipment and the one or more satellite vehicles; and determine no tunnel exit of the user equipment in response to determining that the one or more parameters indicate no line of sight between the user equipment and at least one of the one or more satellite vehicles.

### BRIEF DESCRIPTION OF THE DRAWINGS

FIG. 1 illustrates a simplified diagram of an example communication system including a user equipment and satellite vehicles.

FIG. 2 illustrates an example user equipment.

FIG. 3 illustrates a tunnel entry and tunnel exit of a user equipment.

FIG. 4 illustrates a flow diagram of a method for determining a tunnel exit of a user equipment.

FIG. 5 illustrates a flow diagram of an example method for implementing a tunnel exit prediction process for determining whether parameter(s) based on signals received by the user equipment indicates a line of sight between the user equipment and the satellite vehicles.

FIG. 6 illustrates a flow diagram of a first example implementation of the method of FIG. 5.

FIG. 7 illustrates a flow diagram of a second example implementation of the method of FIG. 5.

FIG. 8 illustrates a flow diagram of a third example implementation of the method of FIG. 5.

FIG. 9 illustrates a flow diagram of a fourth example implementation of the method of FIG. 5.

### DETAILED DESCRIPTION

Obtaining the locations of mobile devices may be useful for many applications including, for example, personal navigation, etc. Existing positioning methods include methods based on measuring signals transmitted from satellite vehicles (SVs). Techniques are discussed herein for determining a tunnel exit of a user equipment based on measuring signals transmitted from satellite vehicles. While the user equipment is located inside the tunnel, the user equipment may be prevented from having a line of sight to satellite vehicles due to blockage from the tunnel walls. After the user equipment exits the tunnel, the user equipment may be able to obtain a line of sight to satellite vehicles and receive signals from the satellite vehicle(s). With the user equipment inside the tunnel and near the tunnel exit, the user equipment may receive signals from the satellite vehicle(s) prior to exiting the tunnel due to multipath interference. To determine whether the user equipment is receiving the signals while inside the tunnel or after exiting the tunnel, the user equipment considers one or more parameters based on the signals and determines whether the parameter(s) indicate a line of sight between the user equipment and the satellite vehicle(s). If the parameters indicate no line of sight, then the signals received by the user equipment may be multipath signals, which may be an indication that the user equipment may not have exited the tunnel (no tunnel exit). If the parameters indicate a line of sight, then the signals received by the user equipment may be received directly from the satellite vehicles, which may indicate that the user equipment may have exited the tunnel. In this manner, the rate of erroneous detections of a tunnel exit due to multipath interference may be reduced. Additionally, the large GNSS positioning errors will be reduced at the tunnel exit and improve user navigation experience. Other capabilities may be provided and not every implementation according to the disclosure must provide any, let alone all, of the capabilities discussed.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

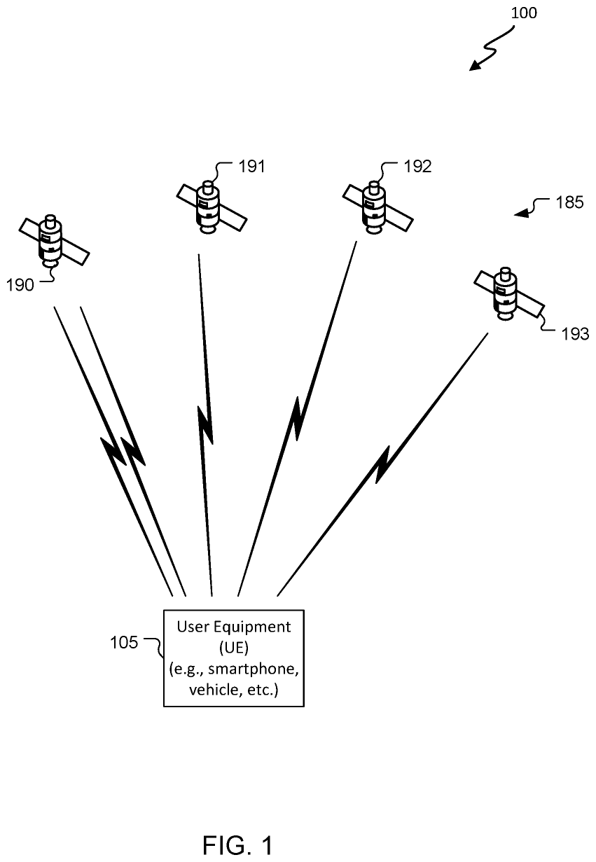

FIG. 1 illustrates a simplified diagram of an example communication system 100 including a user equipment 105 and satellite vehicles (SVs). The user equipment 105 receives and may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). The communication system 100 may include additional or alternative components. With a UE-based position method, the UE 105 may obtain location measurements from signals received from the SVs 190-193 (e.g., measurements may also or instead include measurements of GNSS pseudorange, code phase, and/or carrier phase for the SVs 190-193.) and may compute a location of the UE 105.

As used herein, the term “user equipment” (UE) may be any wireless communication device (e.g., a mobile phone, laptop computer, consumer asset tracking device, etc.) capable of receiving satellite signals. UEs may be embodied by any of a number of types of devices including but not limited to printed circuit (PC) cards, compact flash devices, external or internal modems, wireless or wireline phones, smartphones, tablets, consumer asset tracking devices, asset tags, and so on. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. The UE 105 may be a vehicle-to-everything (V2X) device, such as an On Board Unit (OBU) including a SPS receiver. Other UEs may include wearable devices (e.g., smart watches, smart jewelry, smart glasses, or headsets, etc.). Still other UEs may be used, whether currently existing or developed in the future.

An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

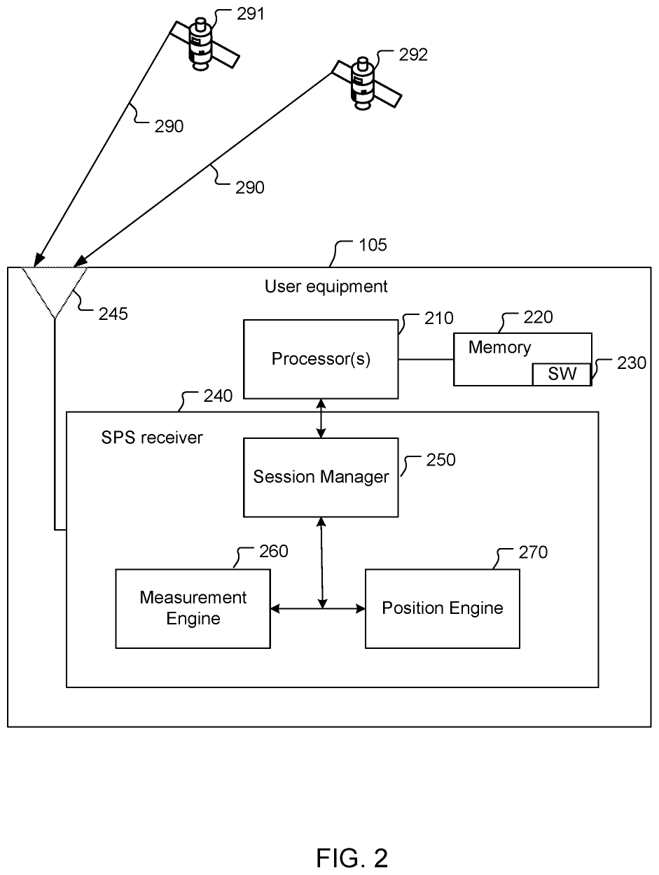

FIG. 2 illustrates an example UE 105. The UE 105 may comprise a computing platform including one or more processors 210, one or more memories 220 including software (SW) 230, and a Satellite Positioning System (SPS) receiver 240. The one or more processors 210 may comprise multiple processors including a general-purpose/application processor. The one or more memories 220 may be a non-transitory storage medium that may include random access memory (RAM), flash memory, disc memory, and/or read-only memory (ROM), etc. The one or more memories 220 may store the software 230 which may be processor-readable, processor-executable software code containing instructions that may be configured to, when executed, cause the processor 210 to perform various functions described herein. Alternatively, the software 230 may not be directly executable by the one or more processors 210 but may be configured to cause the one or more processors 210, e.g., when compiled and executed, to perform the functions. The description herein may refer to the one or more processors 210 performing a function, but this includes other implementations such as where the one or more processors 210 executes software and/or firmware. The description herein may refer to the processor(s) 210 performing a function as shorthand for one or more of the processors performing the function. The description herein may refer to the UE 105 performing a function as shorthand for one or more appropriate components of the UE 105 performing the function. The processor(s) 210 may include one or more memories with stored instructions in addition to and/or instead of the one or more memories 220. Functionality of the one or more processors 210 is discussed more fully below.

The SPS receiver 240 (e.g., a Global Positioning System (GPS) receiver) may be capable of receiving signals 290 from acquired SVs 291, 292 via an SPS antenna 245. The SPS antenna 245 is configured to transduce the signals 290 from wireless signals to wired signals, e.g., electrical or optical signals. The one or more processors 210, the one or more memories 220, and/or one or more specialized processors (not shown) may be utilized to process signals 290, in whole or in part, and/or to calculate an estimated position of the UE 105, in conjunction with the SPS receiver 240. For example, the SPS receiver 240 may be configured to determine a position of the UE 105 by trilateration using the signals 290. The memory 220 may store indications (e.g., measurements) of the signals 290 and/or other signals for use in performing positioning operations. The processor(s) 210, and/or one or more specialized processors, and/or the memory 220 may provide or support a Session Manager (SM) 250, a Measurement Engine 260, and a Position Engine (PE) 270 of the SPS receiver 240. The SM 250 facilitates communication between an application (possibly implemented by the one or more processors 210, possibly in combination with the one or more memories 220) and the ME 260 and the PE 270, and to perform other functions as described herein. The SM 250, the ME 260, and the PE 270 may be implemented using software, hardware, or a combination of software and hardware. The SM 250 receives a request from an application (e.g., a map or navigation application) for a position on the UE 105. The application may be implemented by the one or more processors 210, possibly in combination with the one or more memories 220. The SM 250 sends the request to the ME 260, and the ME 260 initiates a search for SVs. Upon acquiring SVs 291, 292 and receiving signals 290 from the SVs 291, 292, the ME 260 measures the signals 290. The ME 260 sends measurement reports containing the measurements of the signals 290 to the PE 270. The PE 270 determines the position of the UE 105 using the measurements in the measurement reports. The PE 270 sends the position, along with accuracy and reliability information, to the SM 250. The SM 250 qualifies the position of the UE 105, e.g., uses the position accuracy and position reliability information to determine that the position on the UE 105 meets the requirements of the application. The SM 250 sends the qualified position of the UE 105 to the application. If the SM 250 does not qualify the position of the UE 105, the position is not sent to the application. The measurement of the signals 290 by the ME 260, the determination of the position by the PE 270, and the qualification of the position by the SM 250 continues iteratively. The configuration of the UE 105 shown in FIG. 2 is an example and not limiting of the disclosure, including the claims, and other configurations may be used.

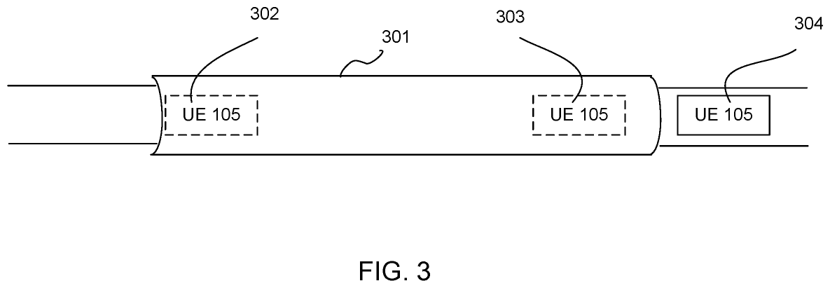

Referring to FIG. 3, in an example environment, a UE 105 may travel through a traffic tunnel 301. For example, at location 302 inside the tunnel 301, the SPS receiver 240 may be prevented from having a line of sight to an SV, and the number of SVs acquired by the SPS receiver 240 may drop to zero. Upon receiving measurement reports from the ME 260 indicating that the number of acquired SVs has dropped to zero, the PE may detect a “tunnel entry”, i.e., that the UE 105 has entered a tunnel 301. At location 304, the UE 105 exits the tunnel 301. After exiting the tunnel 301, the SPS receiver 240 may be able to have a line of sight to one or more SVs. For the SVs 291. 292 acquired by the SPS receiver 240, the ME 260 receives the signals 290. The ME 260 measures the signals 290 and sends new measurement reports to the PE 270. Based on the new measurement reports, the PE 270 determines a position of the UE 105 and may detect a “tunnel exit”, i.e., that the UE 105 is not in the tunnel 301. For example, the PE 270 may detect a tunnel exit when the average number of acquired SVs is greater than two. At location 303, the UE 105 is inside the tunnel 301 and near the tunnel exit. The ME 260 may receive signals 290 from the SVs 291, 292 prior to the UE 105 exiting the tunnel 301 due to multipath interference. Multipath interference may occur if the signals do not arrive directly from an SV (i.e., no line of sight (LOS) between the UE 105 and the SVs 291, 292) but are reflected or diffracted, such as off of buildings or walls. Such reflections or diffractions cause the signals to travel paths of different lengths between the SVs 291, 292 and the SPS antenna 245 and may result in errors in the distance measurements and the determination of the position of the UE 105. The receipt of the multipath signals (e.g., the signals 290 which are reflected or refracted) may lead to an erroneous detection of a tunnel exit by the PE 270 and a reporting of an erroneous position of the UE 105 to the application.

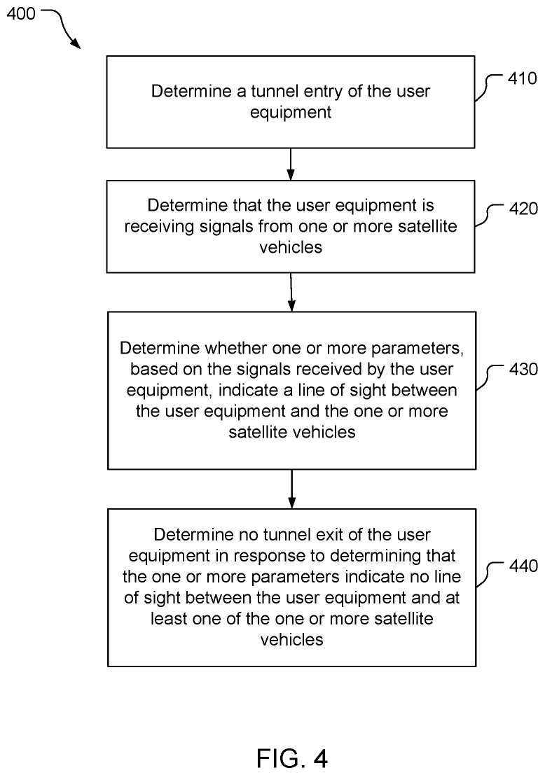

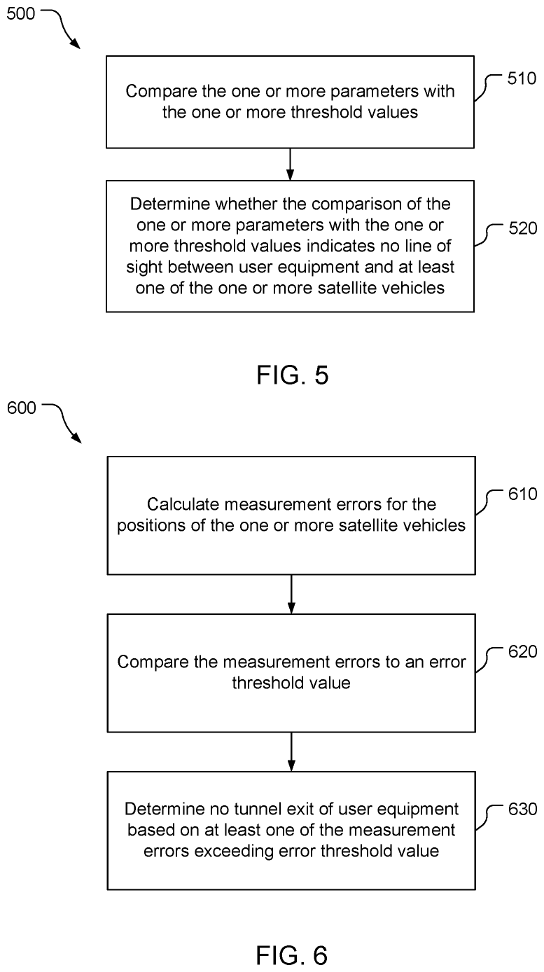

FIG. 4 illustrates a flow diagram for a method 400 for determining a tunnel exit of the UE 105. The implementation of the method 400 includes the following features. The PE 270 determines a tunnel entry of the UE 105 (block 410). For example, a tunnel entry may be detected by the PE 270 in response to the measurement reports from the ME 260 indicating that the number of acquired SVs has dropped to zero. The PE 270 determines that the UE 105 is receiving signals 290 from one or more SVs 291, 292 (block 420). For example, measurement reports from the ME 260 to the PE 270 may indicate that an average number of acquired SVs 291, 292 is greater than two. The PE 270 determines whether one or more parameters, based on the signals 290 received by the UE 105, indicate a line of sight between the UE 105 and the one or more SVs 291. 292 (block 430). For example, the parameter(s) may include measurement errors for the positions of the SVs 291, 292, elevations of the SVs 291, 292, and/or signal strengths of the signals 290 from the SVs 291, 292, etc. For example, based on the measurement reports, the PE 270 initiates a tunnel exit prediction (TEP) process to determine whether the one or more parameters, based on the signals 290, indicate a LOS between the UE 105 and the one or more of SVs 291, 292. The TEP process is described further below with reference to FIGS. 5-9. The PE 270 determines no tunnel exit of the UE 105 in response to determining that the one or more parameters indicate no LOS between the UE 105 and at least one of the SVs 291, 292 (block 440). The one or more processors 210, possibly in combination with the one or more memories 220, in combination with the SPS receiver 240, may comprise means for implementing blocks 410, 420, 430, and 440. By determining the possibility of LOS between the UE 105 and the one or more SVs 291, 292 based on the one or more parameters, the rate of erroneous detections of a tunnel exit due to multipath interference may be reduced.

FIG. 5 illustrates a flow diagram of an example method 500 implementing the TEP process, for determining whether the one or more parameters indicates a LOS between the UE 105 and the SVs 291, 292 based on the signals 290 received by the UE 105. Implementations of the method 500 include the following features. The PE 270 compares the one or more parameters, based on the signals 290 received by the UE 105 from the SVs 291, 292, with one or more threshold values (block 510). Examples of threshold values for one or more parameters are described further below with reference to FIGS. 5-9. The PE 270 determines whether the comparison of the one or more parameters with the one or more threshold values indicates no LOS between the UE 105 and the one or more SVs 291, 292 (block 520). The one or more processors 210, possibly in combination with the one or more memories 220, in combination with the SPS receiver 240, may comprise means for implementing blocks 510 and 520.

FIG. 6 illustrates a flow diagram of a first example implementation 600 of the method 500. The first example implementation 600 includes measurement errors in the one or more parameters and includes the following features. Navigation messages transmitted from the SVs 291, 292 via the signals 290 contain ephemeris information, which can be decoded and used to compute the predicted positions of the SVs 291, 292. In an example, the ephemeris information may be received from other sources, such as a cellular network or other wide area networks. Measured positions of the SVs 291, 292 may be calculated using the measurements of the signals 290. In response to receiving measurement reports from the ME 260 indicating receipt of the signals 290 from the one or more SVs 291, 292, the PE 270 sends a request to the ME 260 to perform a measurement check. In response, the ME 260 calculates measurement errors for the positions of the one or more SVs 291, 292 (block 610). The measurement errors represent ranging errors that may affect the accuracy and reliability of the position of the UE 105 determined based on the measurements in the measurement reports. The ME 260 sends the measurement errors to the PE 270. The PE 270 compares the measurement errors to an error threshold value (block 620). The PE 270 determines no tunnel exit of the UE 105 based on at least one of the measurement errors exceeding the error threshold value (block 630). For example, the error threshold value may be set at 10 meters, with a measurement error exceeding 10 meters indicating that a signal is a multipath signal. A measurement error that does not exceed 10 meters may indicate that the signal was received with a LOS with the corresponding SV. The error threshold value may be tuned based on a desired margin of error for identifying LOS signals as multipath signals. The one or more processors 210, possibly in combination with the one or more memories 220, in combination with the SPS receiver 240, comprise means for implementing blocks 610, 620, and 630. Where at least one, but not all, of the signals from the SVs 291, 292 exceeds the error threshold value, the PE 270 may determine no tunnel exit, since the signal(s) that exceed the error threshold value may be multipath signals, indicating that the UE 105 may be located inside the tunnel 301. The number of signals with measurement errors exceeding the error threshold value for the PE 270 to determine no tunnel exit can be tuned based on the specific capabilities of the SPS receiver 240, the accuracy requirements of the application requesting the position of the UE 105, and/or other factors. The PE 270 may consider additional parameters before determining a tunnel exit, as described further below. If the PE 270 determines a tunnel exit, the position of the UE 105 and the corresponding accuracy and reliability information are sent to the SM 250 to be qualified.

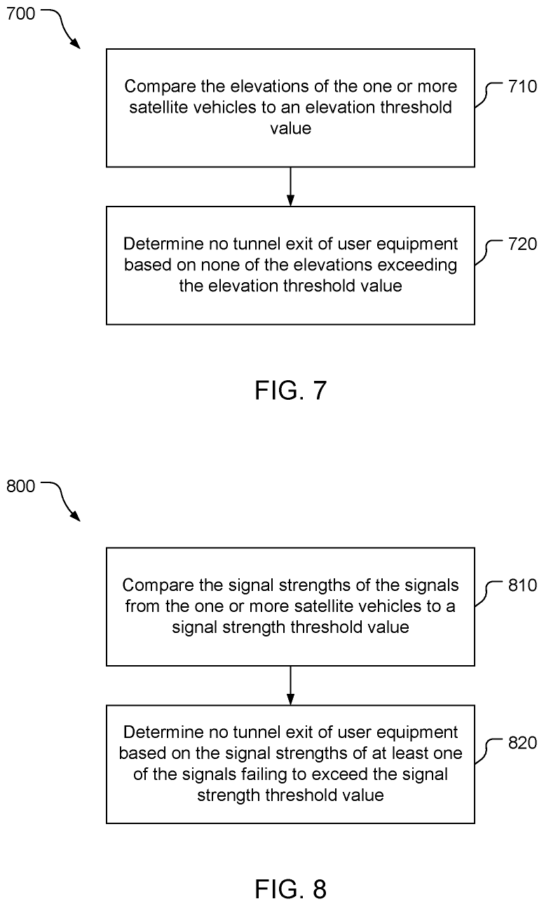

FIG. 7 illustrates a flow diagram of a second example implementation 700 of the method 500. The second example implementation 700 includes elevations of the SVs in the one or more parameters and includes the following features. The elevation of an SV is defined geocentrically and in degrees, with 0 degrees being the horizon and 90 degrees being directly above. The elevation determines the angle at which signals from the SV may be received by the SPS receiver 240. In the context of a UE 105 being in the location 304, near the exit of the tunnel 301 (see FIG. 3), a UE 105 may not be able to obtain a LOS with the SV above a threshold elevation due to the blockage by the tunnel walls but may receive signals from SVs below the threshold elevation. Receiving signals from SVs below the threshold elevation may indicate that the UE 105 has not exited the tunnel 301. The PE 270 obtains the elevations of the one or more SVs 291, 292 from the measurement reports received from the ME 260. The PE 270 compares the elevations of the one or more SVs 291, 292 with an elevation threshold value (block 710). The PE 270 determines no tunnel exit of the UE 105 based on none of the elevations exceeding the elevation threshold value (block 720). For example, the elevation threshold value may be set at 60 degrees, where at an elevation exceeding 60 degrees, the UE 105 may not have a LOS with the SV when inside the tunnel 301. If none of the elevations of the SVs 291, 292 exceeds 60 degrees, then the signals 290 from the SVs 291, 292 may be multipath signals that traveled into the tunnel 301 through the opening at the exit of the tunnel. Thus, receiving the signals 290 from the SVs 291. 292 with elevations failing to exceed the elevation threshold value may indicate that the UE 105 received the signals 290 while inside the tunnel 301. The one or more processors 210, possibly in combination with the one or more memories 220, in combination with the SPS receiver 240, comprise means for implementing blocks 710 and 720.

FIG. 8 illustrates a flow diagram of a third example implementation 800 of the method 500. The third example implementation 800 includes signal strengths in the one or more parameters and includes the following features. Multipath interference may result in a decrease in the strengths of the signals 290. The signals strengths of the signals 290 may indicate whether the signals 290 are multipath signals. The measurement reports received from the ME 260 includes the signals strengths of the signals 290. The PE 270 compares the signal strengths of the signals 290 from the one or more SVs 291, 292 to a signal strength threshold value (block 810). The PE 270 determines no tunnel exit of the UE 105 based on the signal strengths of at least one of the signals 290 failing to exceed the signal strength threshold value (block 820). Having at least one, but not all, of the signals from the SVs 291, 292 failing to exceed the signal strength threshold value may indicate that the signals 290 are multipath signals, further indicating that the UE 105 may be receiving the signals 290 while inside the tunnel 301. The one or more processors 210, possibly in combination with the one or more memories 220, in combination with the SPS receiver 240, comprise means for implementing blocks 810 and 820. For example, the signal strength threshold value may be set 20 dB-Hz, with a signal strength less than 20 dB-Hz indicating that the signal may be a multipath signal. The signal strength threshold value may be tuned based on the characteristics of the SPS antenna 245, the capabilities of components of the SPS receiver 240, and other factors.

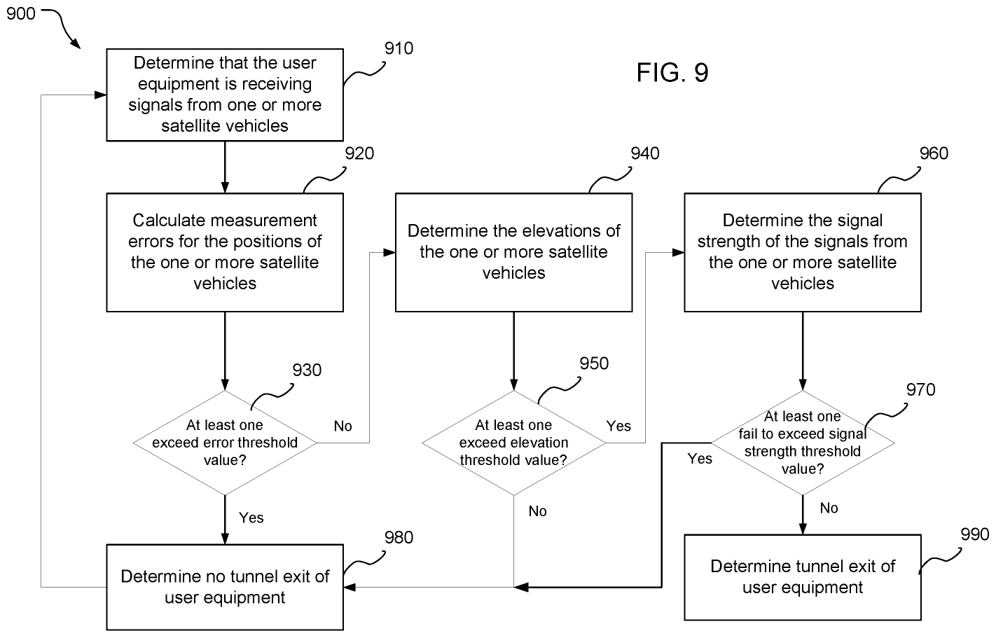

FIG. 9 illustrates a flow diagram of a fourth implementation 900 of the method 500. The fourth example implementation 900 includes a combination of parameters that include measurement errors, elevations of SV, and signal strength and includes the following features. The PE 270 determines that the UE 105 is receiving signals 290 from one or more SVs 291, 292 (block 910) through the receipt of measurement reports from the ME 260. As described above with FIG. 6, the PE 270 sends a request to the ME 260 to perform a measurement check. In response, the ME 260 calculates measurement errors for the positions of the one or more SVs 291, 292 (block 920) and sends the measurement errors to the PE 270. The PE 270 compares the measurement errors to an error threshold value (block 930). The PE 270 determines no tunnel exit of the UE 105 based on at least one of the measurement errors exceeding the error threshold value (block 980).

Based on none of the measurement errors exceeding the error threshold value (block 980), the PE 270 considers the elevations of the SVs 291, 292. As described above with reference to FIG. 7, the PE 270 determines the elevations of the one or more SVs 291, 292 from the measurement reports received from the ME 260 (block 940). The PE 270 compares the elevations of the one or more SVs 291, 292 with an elevation threshold value (block 950). The PE 270 determines no tunnel exit of the UE 105 based on none of the elevations exceeding the elevation threshold value (block 980).

A UE 105 located outside of the tunnel 301 may obtain a LOS with one or more SVs 291. 292 with elevations that exceed the elevation threshold value. To distinguish between signals received from SVs 291, 292 that exceed the elevation threshold value while inside the tunnel 301 versus outside the tunnel 301, the signal strengths of the signals 290 may be considered. The signal strengths of multipath signals may be less than signals received with a LOS between the UE 105 and the SVs 291, 292, due at least in part to the interference caused by the same signal arriving at the SPS antenna 245 at different times. Based on at least one elevation exceeding the elevation threshold value (block 950), the PE 270 determines the signal strength of the signals 290 from the one or more SVs 291, 292 (block 960). The measurement reports received from the ME 260 includes the signals strengths of the signals 290. As described above with reference to FIG. 8, the PE 270 compares the signal strengths of the signals 290 from the one or more SVs 291, 292 to a signal strength threshold value (block 970). The PE 270 determines no tunnel exit of the UE 105 based on the signal strengths of at least one of the signals 290 failing to exceed the signal strength threshold value (block 980). Based on the signals 290 exceeding the signal strength threshold value (block 970), the PE 270 determines a tunnel exit of the UE 105 (block 990). The PE 270 thus determines a tunnel exit based on the signals 290 clearing each of the checks (blocks 930, 950, and 970). The PE 270 may determine no tunnel exit based on the failing of any one or more of the checks (blocks 930, 950, and 970). The one or more processors 210, possibly in combination with the one or more memories 220, in combination with the SPS receiver 240, comprise means for implementing blocks 910-990. In some alternative implementations, the blocks illustrated in FIG. 9 may occur in different orders. For example, two blocks shown in succession may, in fact, be executed substantially concurrently, or the blocks may sometimes be executed in the reverse order.

In one example implementation, weights are applied to the parameters to tune the effect of a parameter on the determination of a tunnel exit or no tunnel exit. One or more of the parameters may be given no effect by setting the corresponding weight to null.

### Implementation Examples

Clause 1. A method for determining a tunnel exit of a user equipment, comprising:
determining a tunnel entry of the user equipment; determining that the user equipment is receiving signals from one or more satellite vehicles;
determining whether one or more parameters based on the signals received by the user equipment indicate a line of sight between the user equipment and the one or more satellite vehicles; and determining no tunnel exit of the user equipment in response to determining that the one or more parameters indicate no line of sight between the user equipment and at least one of the one or more satellite vehicles.

Clause 2. The method of clause 1, wherein the determining of whether the one or more parameters based on the signals indicate the line of sight comprises: comparing the one or more parameters with one or more threshold values.

Clause 3. The method of clause 1, wherein the one or more parameters is selected from a group consisting of: measurement errors for positions of the one or more satellite vehicles; elevations of the one or more satellite vehicles; and signal strengths of the signals from the one or more satellite vehicles.

Clause 4. The method of clause 3, the determining of whether the one or more parameters based on the signals indicate the line of sight and the determining of the no tunnel exit comprise: calculating the measurement errors for the positions of the one or more satellite vehicles; comparing the measurement errors with an error threshold value; and determining the no tunnel exit of the user equipment based on at least one of the measurement errors exceeding the error threshold value.

Clause 5. The method of clause 3, wherein the determining of whether the one or more parameters based on the signals indicate the line of sight and the determining of the no tunnel exit comprise: comparing the elevations of the one or more satellite vehicles to an elevation threshold value; and determining the no tunnel exit of the user equipment based on none of the elevations exceeding the elevation threshold value.

Clause 6. The method of clause 5, wherein in response to determining that at least one of the elevations of the one or more satellite vehicles exceed the elevation threshold value, the method further comprises: comparing the signal strengths of the signals from the one or more satellite vehicles to a signal strength threshold value; and determining a tunnel exit of the user equipment based on the signal strengths of the signals exceeding the signal strength threshold value.

Clause 7. The method of clause 3, the determining of whether the one or more parameters based on the signals indicate the line of sight and the determining of the no tunnel exit comprise: comparing the signal strengths of the signals from the one or more satellite vehicles to a signal strength threshold value; and determining the no tunnel exit of the user equipment based on the signal strengths of at least one of the signals not exceeding the signal strength threshold value.

Clause 8. A computing device, comprising:
means for determining a tunnel entry of the user equipment; means for determining that the user equipment is receiving signals from one or more satellite vehicles;
means for determining whether one or more parameters based on the signals received by the user equipment indicate a line of sight between the user equipment and the one or more satellite vehicles; and
means for determining no tunnel exit of the user equipment in response to determining that the one or more parameters indicate no line of sight between the user equipment and at least one of the one or more satellite vehicles.

Clause 9. The computing device of clause 8, wherein the means for determining whether the one or more parameters based on the signals indicate the line of sight comprises: means for comparing the one or more parameters with one or more threshold values.

Clause 10. The computing device of clause 8, wherein the one or more parameters is selected from a group consisting of: measurement errors for positions of the one or more satellite vehicles; elevations of the one or more satellite vehicles; and signal strengths of the signals from the one or more satellite vehicles.

Clause 11. The computing device of clause 10, the means for determining whether the one or more parameters based on the signals indicate the line of sight and the determining of the no tunnel exit comprise: means for calculating the measurement errors for the positions of the one or more satellite vehicles; means for comparing the measurement errors with an error threshold value; and means for determining the no tunnel exit of the user equipment based on at least one of the measurement errors exceeding the error threshold value.

Clause 12. The computing device of clause 10, wherein the means for determining whether the one or more parameters based on the signals indicate the line of sight and the determining of the no tunnel exit comprise: means for comparing the elevations of the one or more satellite vehicles to an elevation threshold value; and means for determining the no tunnel exit of the user equipment based on none of the elevations exceeding the elevation threshold value.

Clause 13. The computing device of clause 12, further comprising: means for determining that at least one of the elevations of the one or more satellite vehicles exceed the elevation threshold value; means for comparing the signal strengths of the signals from the one or more satellite vehicles to a signal strength threshold value; and means for determining a tunnel exit of the user equipment based on the signal strengths of the signals exceeding the signal strength threshold value.

Clause 14. The computing device of clause 10, wherein the means for determining whether the one or more parameters based on the signals indicate the line of sight and the means for determining the no tunnel exit comprise: means for comparing the signal strengths of the signals from the one or more satellite vehicles to a signal strength threshold value; and means for determining the no tunnel exit of the user equipment based on the signal strengths of at least one of the signals not exceeding the signal strength threshold value.

Clause 15. A non-transitory, processor-readable storage medium comprising processor-readable instructions to cause one or more processors to:
determine a tunnel entry of a user equipment;
determine that the user equipment is receiving signals from one or more satellite vehicles;
determine whether one or more parameters based on the signals received by the user equipment indicate a line of sight between the user equipment and the one or more satellite vehicles; and
determine no tunnel exit of the user equipment in response to determining that the one or more parameters indicate no line of sight between the user equipment and at least one of the one or more satellite vehicles.

Clause 16. The non-transitory, processor-readable storage medium of clause 15, wherein the processor-readable instructions to cause the one or more processors to determine whether the one or more parameters based on the signals indicate the line of sight comprise processor-readable instructions to cause the one or more processors to: compare the one or more parameters with one or more threshold values.

Clause 17. The non-transitory, processor-readable storage medium of clause 15, wherein the one or more parameters is selected from a group consisting of: measurement errors for positions of the one or more satellite vehicles; elevations of the one or more satellite vehicles; and signal strengths of the signals from the one or more satellite vehicles.

Clause 18. The non-transitory, processor-readable storage medium of clause 17, wherein the processor-readable instructions to cause the one or more processors to determine whether the one or more parameters based on the signals indicate the line of sight and the determining of the no tunnel exit comprise processor-readable instructions to cause the one or more processors to: calculate the measurement errors for the positions of the one or more satellite vehicles; compare the measurement errors with an error threshold value; and determine the no tunnel exit of the user equipment based on at least one of the measurement errors exceeding the error threshold value.

Clause 19. The non-transitory, processor-readable storage medium of clause 17, wherein the processor-readable instructions to cause the one or more processors to determine whether the one or more parameters based on the signals indicate the line of sight and the determining of the no tunnel exit comprise processor-readable instructions to cause the one or more processors to: compare the elevations of the one or more satellite vehicles to an elevation threshold value; and determine the no tunnel exit of the user equipment based on none of the elevations exceeding the elevation threshold value.

Clause 20. The non-transitory, processor-readable storage medium of clause 19, further comprising processor-readable instructions to cause the one or more processors to: determine that at least one of the elevations of the one or more satellite vehicles exceed the elevation threshold value; compare the signal strengths of the signals from the one or more satellite vehicles to a signal strength threshold value; and determine a tunnel exit of the user equipment based on the signal strengths of the signals exceeding the signal strength threshold value.

Clause 21. The non-transitory, processor-readable storage medium of clause 17, wherein the processor-readable instructions to cause the one or more processors to determine whether the one or more parameters based on the signals indicate the line of sight and the determining of the no tunnel exit comprise processor-readable instructions to cause the one or more processors to: compare the signal strengths of the signals from the one or more satellite vehicles to a signal strength threshold value; and determine the no tunnel exit of the user equipment based on the signal strengths of at least one of the signals not exceeding the signal strength threshold value.

Clause 22. A user equipment, comprising:
one or more memories; and
one or more processors communicatively coupled to the one or more memories, the one or more processors being configured to:
   determine a tunnel entry of the user equipment;
   determine that the user equipment is receiving signals from one or more satellite vehicles;
   determine whether one or more parameters based on the signals received by the user equipment indicate a line of sight between the user equipment and the one or more satellite vehicles; and
   determine no tunnel exit of the user equipment in response to determining that the one or more parameters indicate no line of sight between the user equipment and at least one of the one or more satellite vehicles.

Clause 23. The user equipment of clause 22, wherein in the determining of whether the one or more parameters based on the signals indicate the line of sight, the one or more processors are configured to: compare the one or more parameters with one or more threshold values.

Clause 24. The user equipment of clause 22, wherein the one or more parameters is selected from a group consisting of: measurement errors for positions of the one or more satellite vehicles; elevations of the one or more satellite vehicles; and signal strengths of the signals from the one or more satellite vehicles.

Clause 25. The user equipment of clause 24, wherein in the determining of whether the one or more parameters based on the signals indicate the line of sight and the determining of the no tunnel exit, the one or more processors are configured to: calculate the measurement errors for the positions of the one or more satellite vehicles; compare the measurement errors with an error threshold value; and determine the no tunnel exit of the user equipment based on at least one of the measurement errors exceeding the error threshold value.

Clause 26. The user equipment of clause 24, wherein in the determining of whether the one or more parameters based on the signals indicate the line of sight and the determining of the no tunnel exit, the one or more processors are configured to: compare the elevations of the one or more satellite vehicles to an elevation threshold value; and determine the no tunnel exit of the user equipment based on none of the elevations exceeding the elevation threshold value.

Clause 27. The user equipment of clause 26, wherein the one or more processors are further configured to: determine that at least one of the elevations of the one or more satellite vehicles exceed the elevation threshold value; compare the signal strengths of the signals from the one or more satellite vehicles to a signal strength threshold value; and determine a tunnel exit of the user equipment based on the signal strengths of the signals exceeding the signal strength threshold value.

Clause 28. The user equipment of clause 24, wherein in the determining of whether the one or more parameters based on the signals indicate the line of sight and the means for determining the no tunnel exit, the one or more processors are configured to: compare the signal strengths of the signals from the one or more satellite vehicles to a signal strength threshold value; and determine the no tunnel exit of the user equipment based on the signal strengths of at least one of the signals not exceeding the signal strength threshold value.

Clause 29. The method of clauses 4, 5, 6 and 7, further comprising: determining no tunnel exit of the user equipment in response to determining that at least one of the measurement errors exceed the error threshold value, none of the elevations exceed the elevation threshold value, or the signal strengths of the signals from the one or more satellite vehicles do not exceed the signal strength threshold value.

Clause 30. The computing device of clauses 11, 12, 13 and 14, further comprises: means for determining no tunnel exit of the user equipment in response to determining that at least one of the measurement errors exceed the error threshold value, none of the elevations exceed the elevation threshold value, or the signal strengths of the signals from the one or more satellite vehicles do not exceed the signal strength threshold value.

Clause 31. The non-transitory, processor-readable storage medium of clauses 18, 19, 20 and 21, wherein the processor-readable instructions further causes the one or more processor to: determine no tunnel exit of the user equipment in response to determining that at least one of the measurement errors exceed the error threshold value, none of the elevations exceed the elevation threshold value, or the signal strengths of the signals from the one or more satellite vehicles do not exceed the signal strength threshold value.

Clause 32. The user equipment of clauses 25, 26, 27, and 28, wherein the one or more processors are further configured to: determine no tunnel exit of the user equipment in response to determining that at least one of the measurement errors exceed the error threshold value, none of the elevations exceed the elevation threshold value, or the signal strengths of the signals from the one or more satellite vehicles do not exceed the signal strength threshold value.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices (e.g., “a processor” includes one or more processors, “the processor” includes one or more processors, “a memory” includes one or more memories, “the memory” includes one or more memories, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of +20% or +10%, +5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of +20% or +10%, +5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method for determining a tunnel exit of a user equipment, comprising:
determining a tunnel entry of the user equipment;
determining that the user equipment is receiving signals from one or more satellite vehicles;
determining whether one or more parameters based on the signals received by the user equipment indicate a line of sight between the user equipment and the one or more satellite vehicles; and
determining no tunnel exit of the user equipment in response to determining that the one or more parameters indicate no line of sight between the user equipment and at least one of the one or more satellite vehicles.

2. The method of claim 1, wherein the determining of whether the one or more parameters based on the signals indicate the line of sight comprises: comparing the one or more parameters with one or more threshold values.

3. The method of claim 1, wherein the one or more parameters is selected from a group consisting of:
measurement errors for positions of the one or more satellite vehicles; elevations of the one or more satellite vehicles; and signal strengths of the signals from the one or more satellite vehicles.

4. The method of claim 3, the determining of whether the one or more parameters based on the signals indicate the line of sight and the determining of the no tunnel exit comprise:
calculating the measurement errors for the positions of the one or more satellite vehicles;
comparing the measurement errors with an error threshold value; and
determining the no tunnel exit of the user equipment based on at least one of the measurement errors exceeding the error threshold value.

5. The method of claim 3, wherein the determining of whether the one or more parameters based on the signals indicate the line of sight and the determining of the no tunnel exit comprise:
comparing the elevations of the one or more satellite vehicles to an elevation threshold value; and
determining the no tunnel exit of the user equipment based on none of the elevations exceeding the elevation threshold value.

6. The method of claim 5, wherein in response to determining that at least one of the elevations of the one or more satellite vehicles exceed the elevation threshold value, the method further comprises:
comparing the signal strengths of the signals from the one or more satellite vehicles to a signal strength threshold value; and
determining a tunnel exit of the user equipment based on the signal strengths of the signals exceeding the signal strength threshold value.

7. The method of claim 3, the determining of whether the one or more parameters based on the signals indicate the line of sight and the determining of the no tunnel exit comprise:
comparing the signal strengths of the signals from the one or more satellite vehicles to a signal strength threshold value; and
determining the no tunnel exit of the user equipment based on the signal strengths of at least one of the signals not exceeding the signal strength threshold value.

8. A computing device, comprising:
means for determining a tunnel entry of a user equipment;
means for determining that the user equipment is receiving signals from one or more satellite vehicles;
means for determining whether one or more parameters based on the signals received by the user equipment indicate a line of sight between the user equipment and the one or more satellite vehicles; and
means for determining no tunnel exit of the user equipment in response to determining that the one or more parameters indicate no line of sight between the user equipment and at least one of the one or more satellite vehicles.

9. The computing device of claim 8, wherein the means for determining whether the one or more parameters based on the signals indicate the line of sight comprises:
means for comparing the one or more parameters with one or more threshold values.

10. The computing device of claim 8, wherein the one or more parameters is selected from a group consisting of:
measurement errors for positions of the one or more satellite vehicles; elevations of the one or more satellite vehicles; and signal strengths of the signals from the one or more satellite vehicles.

11. The computing device of claim 10, the means for determining whether the one or more parameters based on the signals indicate the line of sight and the determining of the no tunnel exit comprise:
means for calculating the measurement errors for the positions of the one or more satellite vehicles;
means for comparing the measurement errors with an error threshold value; and
means for determining the no tunnel exit of the user equipment based on at least one of the measurement errors exceeding the error threshold value.

12. The computing device of claim 10, wherein the means for determining whether the one or more parameters based on the signals indicate the line of sight and the determining of the no tunnel exit comprise:
means for comparing the elevations of the one or more satellite vehicles to an elevation threshold value; and
means for determining the no tunnel exit of the user equipment based on none of the elevations exceeding the elevation threshold value.

13. The computing device of claim 12, further comprising:
means for determining that at least one of the elevations of the one or more satellite vehicles exceed the elevation threshold value;
means for comparing the signal strengths of the signals from the one or more satellite vehicles to a signal strength threshold value; and
means for determining a tunnel exit of the user equipment based on the signal strengths of the signals exceeding the signal strength threshold value.

14. The computing device of claim 10, wherein the means for determining whether the one or more parameters based on the signals indicate the line of sight and the means for determining the no tunnel exit comprise:
means for comparing the signal strengths of the signals from the one or more satellite vehicles to a signal strength threshold value; and
means for determining the no tunnel exit of the user equipment based on the signal strengths of at least one of the signals not exceeding the signal strength threshold value.

15. A non-transitory, processor-readable storage medium comprising processor-readable instructions to cause one or more processors to:
determine a tunnel entry of a user equipment;
determine that the user equipment is receiving signals from one or more satellite vehicles;
determine whether one or more parameters based on the signals received by the user equipment indicate a line of sight between the user equipment and the one or more satellite vehicles; and
determine no tunnel exit of the user equipment in response to determining that the one or more parameters indicate no line of sight between the user equipment and at least one of the one or more satellite vehicles.

16. The non-transitory, processor-readable storage medium of claim 15, wherein the processor-readable instructions to cause the one or more processors to determine whether the one or more parameters based on the signals indicate the line of sight comprise processor-readable instructions to cause the one or more processors to: compare the one or more parameters with one or more threshold values.

17. The non-transitory, processor-readable storage medium of claim 15, wherein the one or more parameters is selected from a group consisting of:
measurement errors for positions of the one or more satellite vehicles; elevations of the one or more satellite vehicles; and signal strengths of the signals from the one or more satellite vehicles.

18. The non-transitory, processor-readable storage medium of claim 17, wherein the processor-readable instructions to cause the one or more processors to determine whether the one or more parameters based on the signals indicate the line of sight and the determining of the no tunnel exit comprise processor-readable instructions to cause the one or more processors to:
calculate the measurement errors for the positions of the one or more satellite vehicles;
compare the measurement errors with an error threshold value; and
determine the no tunnel exit of the user equipment based on at least one of the measurement errors exceeding the error threshold value.

19. The non-transitory, processor-readable storage medium of claim 17, wherein the processor-readable instructions to cause the one or more processors to determine whether the one or more parameters based on the signals indicate the line of sight and the determining of the no tunnel exit comprise processor-readable instructions to cause the one or more processors to:
compare the elevations of the one or more satellite vehicles to an elevation threshold value; and
determine the no tunnel exit of the user equipment based on none of the elevations exceeding the elevation threshold value.

20. The non-transitory, processor-readable storage medium of claim 19, further comprising processor-readable instructions to cause the one or more processors to:
determine that at least one of the elevations of the one or more satellite vehicles exceed the elevation threshold value;
compare the signal strengths of the signals from the one or more satellite vehicles to a signal strength threshold value; and
determine a tunnel exit of the user equipment based on the signal strengths of the signals exceeding the signal strength threshold value.

21. The non-transitory, processor-readable storage medium of claim 17, wherein the processor-readable instructions to cause the one or more processors to determine whether the one or more parameters based on the signals indicate the line of sight and the determining of the no tunnel exit comprise processor-readable instructions to cause the one or more processors to:
compare the signal strengths of the signals from the one or more satellite vehicles to a signal strength threshold value; and
determine the no tunnel exit of the user equipment based on the signal strengths of at least one of the signals not exceeding the signal strength threshold value.

22. A user equipment, comprising:
one or more memories; and
one or more processors communicatively coupled to the one or more memories, the one or more processors being configured to:
determine a tunnel entry of the user equipment;
determine that the user equipment is receiving signals from one or more satellite vehicles;
determine whether one or more parameters based on the signals received by the user equipment indicate a line of sight between the user equipment and the one or more satellite vehicles; and
determine no tunnel exit of the user equipment in response to determining that the one or more parameters indicate no line of sight between the user equipment and at least one of the one or more satellite vehicles.

23. The user equipment of claim 22, wherein in the determining of whether the one or more parameters based on the signals indicate the line of sight, the one or more processors are configured to: compare the one or more parameters with one or more threshold values.

24. The user equipment of claim 22, wherein the one or more parameters is selected from a group consisting of:
measurement errors for positions of the one or more satellite vehicles; elevations of the one or more satellite vehicles; and signal strengths of the signals from the one or more satellite vehicles.

25. The user equipment of claim 24, wherein in the determining of whether the one or more parameters based on the signals indicate the line of sight and the determining of the no tunnel exit, the one or more processors are configured to:
calculate the measurement errors for the positions of the one or more satellite vehicles;
compare the measurement errors with an error threshold value; and
determine the no tunnel exit of the user equipment based on at least one of the measurement errors exceeding the error threshold value.

26. The user equipment of claim 24, wherein in the determining of whether the one or more parameters based on the signals indicate the line of sight and the determining of the no tunnel exit, the one or more processors are configured to:
compare the elevations of the one or more satellite vehicles to an elevation threshold value; and
determine the no tunnel exit of the user equipment based on none of the elevations exceeding the elevation threshold value.

27. The user equipment of claim 26, wherein the one or more processors are further configured to:
determine that at least one of the elevations of the one or more satellite vehicles exceed the elevation threshold value;
compare the signal strengths of the signals from the one or more satellite vehicles to a signal strength threshold value; and
determine a tunnel exit of the user equipment based on the signal strengths of the signals exceeding the signal strength threshold value.

28. The user equipment of claim 24, wherein in the determining of whether the one or more parameters based on the signals indicate the line of sight and the means for determining the no tunnel exit, the one or more processors are configured to:
compare the signal strengths of the signals from the one or more satellite vehicles to a signal strength threshold value; and
determine the no tunnel exit of the user equipment based on the signal strengths of at least one of the signals not exceeding the signal strength threshold value.
